(19) United States
(12) Patent Application Publication
(10) Pub. No.: US 2025/0377880 A1
(43) Pub. Date: Dec. 11, 2025

(54) AUTOMATED DETECTION AND IMPLEMENTATION OF OBSERVABILITY INTERFACE CHANGES

(71) Applicant: International Business Machines Corporation, Armonk, NY (US)

(72) Inventors: Bikram Debnath, Bangalore (IN); RAJESH KUMAR JEYAPAUL, Bangalore (IN); Vipin Mullilengil Vellilopullithodi, Bangalore (IN); Padmini Krishnamurthy, Bangalore (IN); SANDHYA R., Bangalore (IN)

(73) Assignee: International Business Machines Corporation, Armonk, NY (US)

(21) Appl. No.: 18/738,348

(22) Filed: Jun. 10, 2024

(51) Int. Cl. G06F 8/65; G06F 8/71

(52) U.S. Cl. CPC G06F 8/65; G06F 8/71

(57) ABSTRACT

An embodiment constructs, from a tag in source code of a monitoring application, a keyword set, the tag indicating a target system monitoring query dependent on a changeable monitoring interface, a keyword in the keyword set corresponding to a parameter of the system monitoring query. An embodiment extracts, from source code documentation of the changeable monitoring interface, a code change event corresponding to a keyword in the keyword set. An embodiment deploys, responsive to determining that an updated version of the monitoring application implements an update to the target system monitoring query triggered by the code change event, the updated version of the monitoring application.

### BACKGROUND

The present invention relates generally to computer system and application observability management. More particularly, the present invention relates to a method, system, and computer program for automated detection and implementation of observability interface changes.

In computing, observability is the ability to collect data about computer systems and the applications executing on computer systems, including programs' execution, modules' internal states, and communication among components of an application or between computer systems. To improve observability, those responsible for a computer system or its applications use a wide range of logging and tracing techniques to gather performance metrics and other telemetry information, and tools to analyze and use the information. The system and applications being monitored are also referred to as a metric source system or a target system. Typically, a sensor application, also referred to as an observer application or monitoring application, requests data from the target system. A metric is a point in time measurement that represents some system state. Some examples of application and system metrics include the number of hypertext transport protocol (HTTP) requests per second, total number of query failures, database size in bytes, time in seconds since last garbage collection, current processor utilization percentage, current memory utilization percentage, system throughput, a current number of reads and writes per second, and the like. An observer application is typically configured to monitor current values of selected metrics, and emit an alert when certain metric values exceed set thresholds.

A monitoring application monitoring a variety of different host environments and applications, using a variety of technologies, depends on a variety of observability interfaces or monitoring interfaces to collect data from a target system. For example, a target system such as a server might expose one interface to an observer application, while applications executing on the target system might expose a different interface. Some typically used interfaces include a structured query language (SQL) interface, an application programming interface (API), an operating system-specific command, and an Open Data Protocol (OData) data model. OData is a standard that defines a set of best practices for building and consuming APIs, allowing resources identified using Uniform Resource Locators (URLs) and defined in a data model to be published and edited by a client communicating via a communications network such as the Internet.

The illustrative embodiments recognize that a change to a host environment or application could change an interface a monitoring application is using. If the change is unexpected, the monitoring application might not be able to collect, monitor, or analyze observability metrics, fail to observe an event, or the monitoring application might become unstable or fail altogether. The monitoring application might also be unable to analyze the failure, necessitating investigation by a human expert. Presently, one mitigation option is to have a human expert update the monitoring application, after learning of an interface change via software documentation or by investigating a monitoring application failure. However, notification of changes in diverse interfaces can come from a variety of sources and is not always well documented. For example, a change to an API might be publicly documented, but changes pertaining to an SQL interface or the internal data of an operating system or kernel libraries is often not publicly documented. As well, once a monitoring application has been developed and deployed in a production environment, those responsible for a monitoring application are likely to be unfamiliar with details of the particular interfaces and metrics being monitored, and thus fail to anticipate a need to update the monitoring application even when a change to an interface is documented.

Thus, the illustrative embodiments recognize that there is a need to indicate, by a monitoring application developer, aspects of an interface a monitoring application uses, automatically detect relevant changes in the interface, and update the monitoring application to use a changed interface.

### SUMMARY

The illustrative embodiments provide for automated detection and implementation of observability interface changes. An embodiment includes constructing, from a tag in source code of a monitoring application, a keyword set, the tag indicating a target system monitoring query dependent on a changeable monitoring interface, a keyword in the keyword set corresponding to a parameter of the system monitoring query. The embodiment includes extracting, from source code documentation of the changeable monitoring interface, a code change event corresponding to a keyword in the keyword set. The embodiment includes deploying, responsive to determining that an updated version of the monitoring application implements an update to the target system monitoring query triggered by the code change event, the updated version of the monitoring application. Thus, the embodiment provides automated detection and implementation of observability interface changes. Other embodiments of this aspect include corresponding computer systems, apparatus, and computer programs recorded on one or more computer storage devices, each configured to perform the actions of the embodiment.

In another embodiment, the keyword set is constructed using a tag-to-keyword dictionary. Thus, the embodiment provides additional detail of a keyword set used in automated detection and implementation of observability interface changes.

In another embodiment, the tag-to-keyword dictionary comprises an additional keyword corresponding to the tag. Thus, the embodiment provides additional detail of a tag-to-keyword dictionary used in automated detection and implementation of observability interface changes.

In another embodiment, extracting the code change event further comprises detecting an addition to a source code repository, the addition comprising a document describing the addition; generating, using a natural language processing engine, a summary of the document; determining, by comparing the summary to the keyword set, that the document comprises the code change event; and extracting, from the summary, the code change event. Thus, the embodiment provides additional detail of extracting the code change event in automated detection and implementation of observability interface changes.

Another embodiment further includes generating, responsive to determining that an implementation of the update to the target system monitoring query is triggered by the code change event, an update request comprising the code change event and a request to perform the implementation. Thus, the embodiment provides additional detail of implementation of observability interface changes.

Another embodiment further includes generating, using a code generation tool, the implementation. Thus, the embodiment provides additional detail of automated implementation of observability interface changes.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example configuration for automated detection and implementation of observability interface changes in accordance with an illustrative embodiment;

FIG. 3 depicts an example of automated detection and implementation of observability interface changes in accordance with an illustrative embodiment;

FIG. 4 depicts a continued example of automated detection and implementation of observability interface changes in accordance with an illustrative embodiment;

FIG. 5 depicts a continued example of automated detection and implementation of observability interface changes in accordance with an illustrative embodiment; and

FIG. 6 depicts a flowchart of an example process for automated detection and implementation of observability interface changes in accordance with an illustrative embodiment.

### DETAILED DESCRIPTION

The illustrative embodiments recognize that there is a need to indicate, by a monitoring developer, aspects of an interface a monitoring application uses, automatically detect relevant changes in the interface, and update the monitoring application to use a changed monitoring interface.

The present disclosure addresses the deficiencies described above by providing a process (as well as a system, method, machine-readable medium, etc.) that constructs, from a tag in source code of a monitoring application, a keyword set; extracts, from source code documentation of a changeable monitoring interface, a code change event corresponding to a keyword in the keyword set; and deploys, responsive to determining that a updated version of the monitoring application implements a update to the target system monitoring query triggered by the code change event, the updated version of the monitoring application. Thus, the illustrative embodiments provide for automated detection of network anomalies and generation of optimized anomaly-alleviating incentives.

During development of a monitoring application, an application developer inserts one or more tags into source code of a monitoring application intended to monitor a target system. A tag indicates a target system monitoring query dependent on a changeable monitoring interface, and a particular aspect or characteristic of that changeable monitoring interface that might require a monitoring application update. One embodiment uses four types of tags: a @TagProcessor tag indicates to the embodiment that the following tags need to be processed, a @Technology tag identifies one or more technologies associated with the interface, a @PMI tag identifies the particular interface being used, and a @Scope tag indicates one or more keywords associated with the interface. For example, @Technology (value=“DB2”) might identify the DB2 relational database technology, while @Technology (value=“Ubuntu”) might identify the Ubuntu variant of the Linux operating system. (DB2 is a registered trademark of International Business Machines Corporation in the United States and other countries. Ubuntu is a registered trademark of Canonical Limited in the United States and other countries. Linux is a registered trademark of Linus Torvalds in the United States and other countries.) As another example, @PMI (Value=“SQL”) might indicate that a SQL interface is being used, while @PMI (Value=“Utility”) might indicate that a utility interface is being used. As another example, @scope (Value=“deprecation, column”) might indicate that “deprecation” (because deprecation often implies a change to a different interface, query function, or format) and “column” (because, in a database query, columns are typically an important parameter, and thus a change involving a column often implies a change to data returned by the query) are keywords associated with an interface change that might require a monitoring application update. Other tagging schemes, for example omitting the tag indicating that other tags are coming up, using more or fewer tag types, using different names for tag types, or using different indications of the value of a tag, are also possible and contemplated within the scope of the illustrative embodiments.

From one or more tags and tag values, an illustrative embodiment constructs a keyword set. A keyword in the keyword set corresponds to a parameter of a tagged system monitoring query. In particular, an embodiment reads a file containing tagged source code, and adds each tag value to the keyword set.

An embodiment supplements the keyword set with additional keywords stored in a tag-to-keyword dictionary. The additional keywords are keywords that could be helpful in determining that a document contains documentation of an interface change that might require a monitoring application update. For example, for a keyword that includes a particular database table name, the dictionary might store additional keywords such as “database”, “table”, “column”, “old table”, “new table”, “table replacement”, “column replacement”, and the like. One embodiment maintains different dictionary portions for technology, interface, and scope tag values, and uses a tag's type to select one or more additional keywords from only a portion of the dictionary. An embodiment populates contents of the tag-to-keyword dictionary using a presently available automated technique, or receives contents of the tag-to-keyword dictionary from a human expert or another preexisting source.

An embodiment has access to source code documentation of the changeable monitoring interface. Some non-limiting examples of source code documentation are documentation accompanying storage of a new version of an application or operating system in a source code repository, a press release documenting a new version of an application or operating system, documentation of a new or updated API intended for other applications' use, and the like. One embodiment detects an addition to a source code repository. The detected addition includes a document describing the addition. For example, the addition might be an update to Application A, and the document might include a description of the changes to Application A in the update.

An embodiment extracts a code change event corresponding to a keyword in the keyword set from source code documentation of the changeable monitoring interface. A code change event is text describing a code change event. For example, if the documentation describes an update to API 123, and the keyword set includes “API 123”, the code change event might include the documented description of what precisely has changed in API 123 (e.g., an additional calling parameter of the API has been defined, or the API now supports additional functionality.) In particular, an embodiment uses a presently available natural language processing engine to generate a summary of a document in source code documentation of the changeable monitoring interface, and determines, by comparing the summary to the keyword set, that the document comprises a code change event corresponding to a keyword in the keyword set. Another embodiment does not generate a summary, and instead determines, by comparing the un-summarized document to the keyword set, that the document, or a portion of the document, comprises a code change event corresponding to a keyword in the keyword set. Techniques for comparing a document, summary, or portion of a document to a set of keywords are presently available. An embodiment uses a presently available natural language processing engine to extract the code change event from the document, summary, or portion.

An embodiment determines whether or not an updated version of the monitoring application already implements an update to the target system monitoring query triggered by the code change event. If an updated version already implements the update, an embodiment deploys the updated version of the monitoring application, thus keeping the monitoring application consistent with changes to the changeable monitoring interface.

If an updated version does not already implement the update, an embodiment generates an update request for the monitoring application. The update request includes the code change event and a request to perform the implementation. One embodiment routes the update request to a human developer, who will perform the required updates to the monitoring application. Another embodiment uses a presently available natural language document extraction technique to extract a description of the required source code change from the text of the code change event, and uses a presently available code generation tool or technique to generate the required updates to the monitoring application. An embodiment then deploys the updated version of the monitoring application, thus keeping the monitoring application consistent with changes to the changeable monitoring interface.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same arc contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

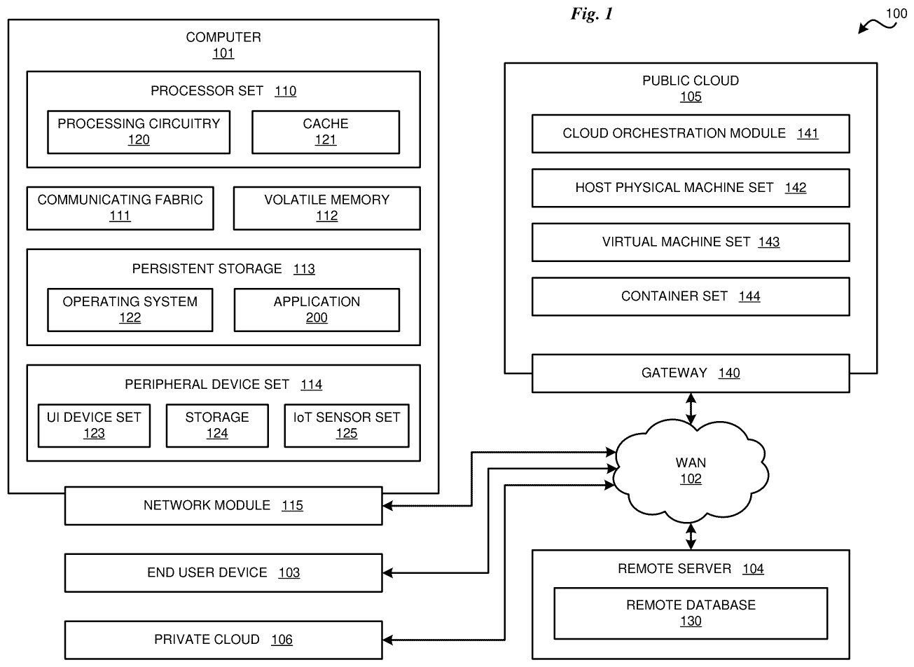

With reference to FIG. 1, this figure depicts a block diagram of a computing environment 100. Computing environment 100 contains an example of an environment for the execution of at least some of the computer code involved in performing the inventive methods, such as application 200 that provides automated detection and implementation of observability interface changes. In addition to application 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and application 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in application 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

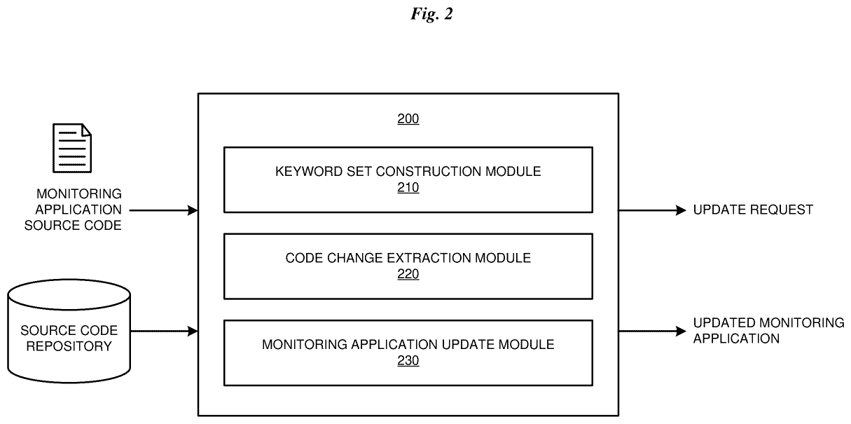

With reference to FIG. 2, this figure depicts a block diagram of an example configuration for automated detection and implementation of observability interface changes in accordance with an illustrative embodiment. Application 200 is the same as application 200 in FIG. 1.

During development of a monitoring application, an application developer inserts one or more tags into source code of a monitoring application intended to monitor a target system. A tag indicates a target system monitoring query dependent on a changeable monitoring interface, and a particular aspect or characteristic of that changeable monitoring interface that might require a monitoring application update. One implementation of application 200 uses four types of tags: a @TagProcessor tag indicates to the embodiment that the following tags need to be processed, a @Technology tag identifies one or more technologies associated with the interface, a @PMI tag identifies the particular interface being used, and a @Scope tag indicates one or more keywords associated with the interface. For example, @Technology (value=“DB2”) might identify the DB2 relational database technology, while @Technology (value=“Ubuntu”) might identify the Ubuntu variant of the Linux operating system. As another example, @PMI (Value=“SQL”) might indicate that a SQL interface is being used, while @PMI (Value=“Utility”) might indicate that a utility interface is being used. As another example, @scope (Value=“deprecation, column”) might indicate that “deprecation” (because deprecation often implies a change to a different interface, query function, or format) and “column” (because, in a database query, columns are typically an important parameter, and thus a change involving a column often implies a change to data returned by the query) are keywords associated with an interface change that might require a monitoring application update. Other tagging schemes, for example omitting the tag indicating that other tags are coming up, using more or fewer tag types, using different names for tag types, or using different indications of the value of a tag, are also possible.

In the illustrated embodiment, from one or more tags and tag values, keyword set construction module 210 constructs a keyword set. A keyword in the keyword set corresponds to a parameter of a tagged system monitoring query. In particular, module 210 reads a file containing tagged source code, and adds each tag value to the keyword set.

One implementation of module 210 supplements the keyword set with additional keywords stored in a tag-to-keyword dictionary. The additional keywords are keywords that could be helpful in determining that a document contains documentation of an interface change that might require a monitoring application update. For example, for a keyword that includes a particular database table name, the dictionary might store additional keywords such as “database”, “table”, “column”, “old table”, “new table”, “table replacement”, “column replacement”, and the like. One implementation of module 210 maintains different dictionary portions for technology, interface, and scope tag values, and uses a tag's type to select one or more additional keywords from only a portion of the dictionary. Module 210 populates contents of the tag-to-keyword dictionary using a presently available automated technique, or receives contents of the tag-to-keyword dictionary from a human expert or another preexisting source.

Code change extraction module 220 has access to source code documentation of the changeable monitoring interface. Some non-limiting examples of source code documentation are documentation accompanying storage of a new version of an application or operating system in a source code repository, a press release documenting a new version of an application or operating system, documentation of a new or updated API intended for other applications' use, and the like. One implementation of module 220 detects an addition to a source code repository. The detected addition includes a document describing the addition. For example, the addition might be an update to Application A, and the document might include a description of the changes to Application A in the update.

Module 220 extracts a code change event corresponding to a keyword in the keyword set from source code documentation of the changeable monitoring interface. A code change event is text describing a code change event. For example, if the documentation describes an update to API 123, and the keyword set includes “API 123”, the code change event might include the documented description of what precisely has changed in API 123 (e.g., an additional calling parameter of the API has been defined, or the API now supports additional functionality.) In particular, module 220 uses a presently available natural language processing engine to generate a summary of a document in source code documentation of the changeable monitoring interface, and determines, by comparing the summary to the keyword set, that the document comprises a code change event corresponding to a keyword in the keyword set. Another implementation of module 220 does not generate a summary, and instead determines, by comparing the un-summarized document to the keyword set, that the document, or a portion of the document, comprises a code change event corresponding to a keyword in the keyword set. Techniques for comparing a document, summary, or portion of a document to a set of keywords are presently available. Module 220 uses a presently available natural language processing engine to extract the code change event from the document, summary, or portion.

Monitoring application update module 230 determines whether or not an updated version of the monitoring application already implements an update to the target system monitoring query triggered by the code change event. If an updated version already implements the update, module 230 deploys the updated version of the monitoring application, thus keeping the monitoring application consistent with changes to the changeable monitoring interface.

If an updated version does not already implement the update, module 230 generates an update request for the monitoring application. The update request includes the code change event and a request to perform the implementation. One implementation of module 230 routes the update request to a human developer, who will perform the required updates to the monitoring application. Another implementation of module 230 uses a presently available natural language document extraction technique to extract a description of the required source code change from the text of the code change event, and uses a presently available code generation tool or technique to generate the required updates to the monitoring application. Module 230 then deploys the updated version of the monitoring application, thus keeping the monitoring application consistent with changes to the changeable monitoring interface.

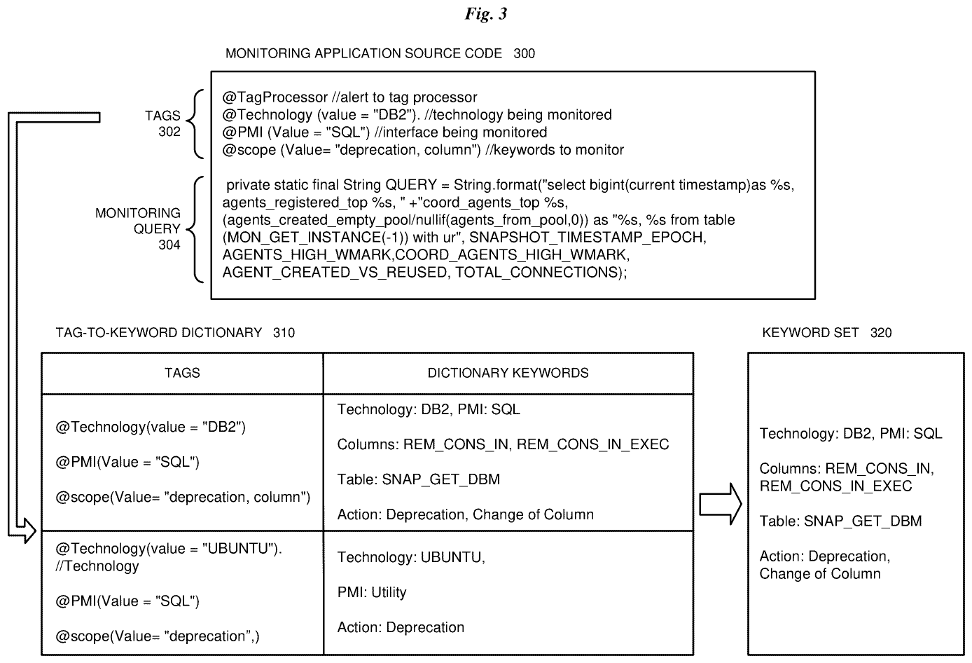

With reference to FIG. 3, this figure depicts an example of automated detection and implementation of observability interface changes in accordance with an illustrative embodiment. The example can be executed using application 200 in FIG. 2.

Monitoring application source code 300 is an example of source code of a monitoring application intended to monitor a target system. Source code 300 includes example tags 302 and monitoring query 304. Monitoring query uses a changeable monitoring interface that might require a monitoring application update, and tags 302 indicate particular aspects or characteristics of the changeable monitoring interface that might require a monitoring application update. Tags 302 includes examples of four types of tags: a @TagProcessor tag indicates to the embodiment that the following tags need to be processed, a @Technology tag identifies one or more technologies associated with the interface, a @PMI tag identifies the particular interface being used, and a @Scope tag indicates one or more keywords associated with the interface. For example, @Technology (value=“DB2”) might identify the DB2 relational database technology, while @Technology (value=“Ubuntu”) might identify the Ubuntu variant of the Linux operating system. As another example, @PMI (Value=“SQL”) might indicate that a SQL interface is being used, while @PMI (Value=“Utility”) might indicate that a utility interface is being used. As another example, @scope (Value=“deprecation, column”) might indicate that “deprecation” (because deprecation often implies a change to a different interface, query function, or format) and “column” (because, in a database query, columns are typically an important parameter, and thus a change involving a column often implies a change to data returned by the query) are keywords associated with an interface change that might require a monitoring application update.

Tag-to-keyword dictionary 310 includes additional keywords that could be helpful in determining that a document contains documentation of an interface change that might require a monitoring application update. For example, for the SQL keyword, dictionary 310 includes additional keywords specifying specific database table and column names that are often used in a monitoring interface using SQL. One implementation of module 210 uses tags 302 and dictionary 310 to generate keyword set 320, including keywords from tags 302 and additional keywords from dictionary 310. Note that keyword set 320 does not include irrelevant portions of dictionary 310, such as the Ubuntu-related keywords.

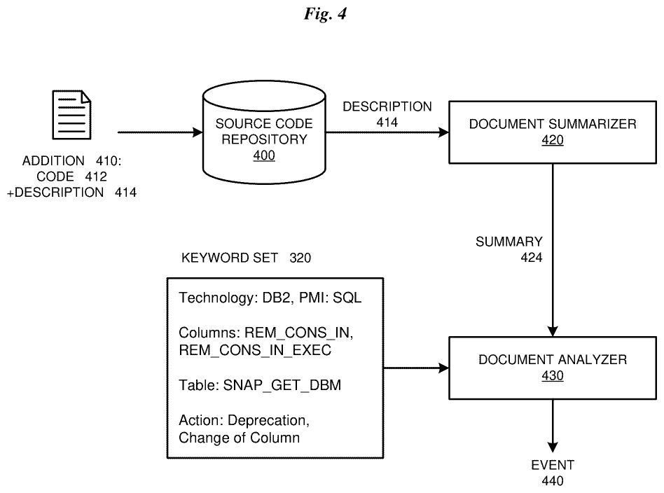

With reference to FIG. 4, this figure depicts a continued example of automated detection and implementation of observability interface changes in accordance with an illustrative embodiment. Keyword set 320 is the same as keyword set 320 in FIG. 3.

Addition 410 is a new version of an application or operating system being stored in source code repository 400. Addition 410 includes code 412 and description 414, a document describing addition 410. Document summarizer 420 uses a presently available natural language processing engine to generate summary 424 of description 414. Document analyzer 430 determines, by comparing summary 424 to keyword set 320, that description 414 comprises event 440, a code change event corresponding to a keyword in keyword set 320.

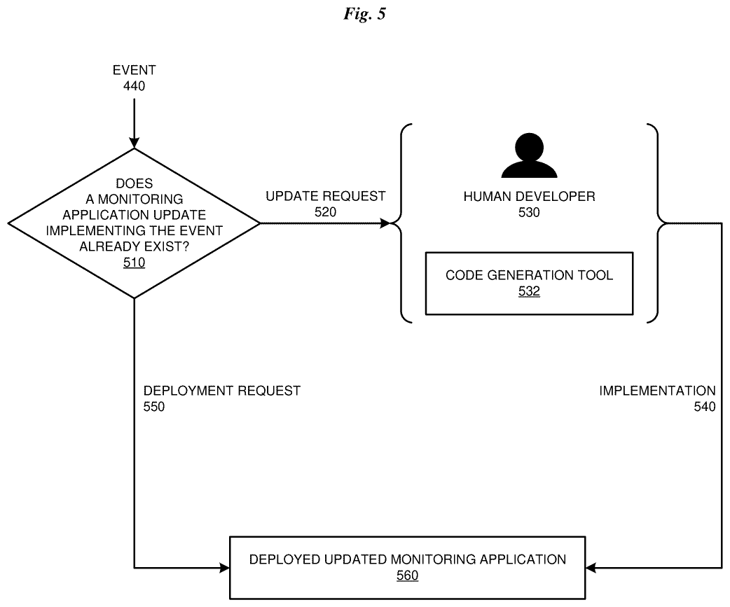

With reference to FIG. 5, this figure depicts a continued example of automated detection and implementation of observability interface changes in accordance with an illustrative embodiment. Event 440 is the same as event 440 in FIG. 4.

In block 510, monitoring application update module 230 determines whether or not an updated version of the monitoring application already implements an update to the target system monitoring query triggered by the code change event. If an updated version already implements the update, module 230 generates deployment request 550. In response, deployed updated monitoring application 560 denotes deployment of the updated version of the monitoring application, thus keeping the monitoring application consistent with changes to the changeable monitoring interface.

If an updated version does not already implement the update, module 230 generates update request 520 for the monitoring application. Update request 520 includes the code change event and a request to perform the implementation. Update request 520 is routed to human developer 530, who will perform implementation 540, updates to the monitoring application triggered by event 440. Alternatively, update request 520 is routed to code generation tool 532, which uses a presently available natural language document extraction technique to extract a description of the required source code change from the text of the code change event, and uses a presently available code generation tool or technique to generate implementation 540, updates to the monitoring application triggered by event 440. Deployed updated monitoring application 560 denotes deployment of the updated version of the monitoring application, thus keeping the monitoring application consistent with changes to the changeable monitoring interface.

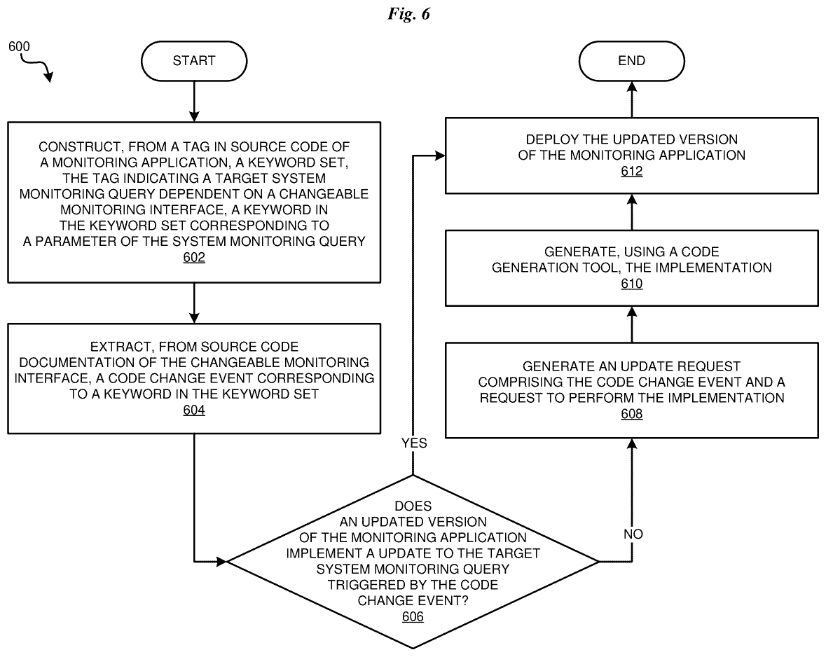

With reference to FIG. 6, this figure depicts a flowchart of an example process for automated detection and implementation of observability interface changes in accordance with an illustrative embodiment. Process 600 can be implemented in application 200 in FIG. 2.

In the illustrated embodiment, at block 602, the process constructs, from a tag in source code of a monitoring application, a keyword set, the tag indicating a target system monitoring query dependent on a changeable monitoring interface, a keyword in the keyword set corresponding to a parameter of the system monitoring query. At block 604, the process extracts, from source code documentation of the changeable monitoring interface, a code change event corresponding to a keyword in the keyword set. At block 606, the process determines whether an updated version of the monitoring application implement an update to the target system monitoring query triggered by the code change event. If not (“NO” path of block 606), at block 608 the process generates an update request comprising the code change event and a request to perform the implementation, and at block 610 the process generates, using a code generation tool, the implementation. Then (also “YES” path of block 606), at block 612 the process deploys the updated version of the monitoring application. Then the process ends.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively. present invention is not limited to a particular combination thereof. To the contrary, such embodiments may also be combined in any way and number according to the intended deployment of present invention without losing their beneficial effects.

What is claimed is:

1. A computer-implemented method comprising:
constructing, from a tag in source code of a monitoring application, a keyword set, the tag indicating a target system monitoring query dependent on a changeable monitoring interface, a keyword in the keyword set corresponding to a parameter of the target system monitoring query;
extracting, from source code documentation of the changeable monitoring interface, a code change event corresponding to a keyword in the keyword set; and
deploying, responsive to determining that an updated version of the monitoring application implements an update to the target system monitoring query triggered by the code change event, the updated version of the monitoring application.

2. The computer-implemented method of claim 1, wherein the keyword set is constructed using a tag-to-keyword dictionary.

3. The computer-implemented method of claim 2, wherein the tag-to-keyword dictionary comprises an additional keyword corresponding to the tag.

4. The computer-implemented method of claim 1, wherein extracting the code change event further comprises:
detecting an addition to a source code repository, the addition comprising a document describing the addition;
generating, using a natural language processing engine, a summary of the document;
determining, by comparing the summary to the keyword set, that the document comprises the code change event; and
extracting, from the summary, the code change event.

5. The computer-implemented method of claim 1, further comprising:
generating, responsive to determining that an implementation of the update to the target system monitoring query is triggered by the code change event, an update request comprising the code change event and a request to perform the implementation.

6. The computer-implemented method of claim 5, further comprising:
generating, using a code generation tool, the implementation.

7. A computer program product comprising one or more computer readable storage media, and program instructions collectively stored on the one or more computer readable storage media, the program instructions executable by a processor to cause the processor to perform operations comprising:
constructing, from a tag in source code of a monitoring application, a keyword set, the tag indicating a target system monitoring query dependent on a changeable monitoring interface, a keyword in the keyword set corresponding to a parameter of the target system monitoring query;
extracting, from source code documentation of the changeable monitoring interface, a code change event corresponding to a keyword in the keyword set; and
deploying, responsive to determining that an updated version of the monitoring application implements an update to the target system monitoring query triggered by the code change event, the updated version of the monitoring application.

8. The computer program product of claim 7, wherein the stored program instructions are stored in a computer readable storage device in a data processing system, and wherein the stored program instructions are transferred over a network from a remote data processing system.

9. The computer program product of claim 7, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

10. The computer program product of claim 7, wherein the keyword set is constructed using a tag-to-keyword dictionary.

11. The computer program product of claim 10, wherein the tag-to-keyword dictionary comprises an additional keyword corresponding to the tag.

12. The computer program product of claim 7, wherein extracting the code change event further comprises:
detecting an addition to a source code repository, the addition comprising a document describing the addition;
generating, using a natural language processing engine, a summary of the document;
determining, by comparing the summary to the keyword set, that the document comprises the code change event; and
extracting, from the summary, the code change event.

13. The computer program product of claim 7, further comprising:
generating, responsive to determining that an implementation of the update to the target system monitoring query is triggered by the code change event, an update request comprising the code change event and a request to perform the implementation.

14. The computer program product of claim 13, further comprising:
generating, using a code generation tool, the implementation.

15. A computer system comprising a processor and one or more computer readable storage media, and program instructions collectively stored on the one or more computer readable storage media, the program instructions executable by the processor to cause the processor to perform operations comprising:
constructing, from a tag in source code of a monitoring application, a keyword set, the tag indicating a target system monitoring query dependent on a changeable monitoring interface, a keyword in the keyword set corresponding to a parameter of the target system monitoring query;
extracting, from source code documentation of the changeable monitoring interface, a code change event corresponding to a keyword in the keyword set; and
deploying, responsive to determining that an updated version of the monitoring application implements an update to the target system monitoring query triggered by the code change event, the updated version of the monitoring application.

16. The computer system of claim 15, wherein the keyword set is constructed using a tag-to-keyword dictionary.

17. The computer system of claim 16, wherein the tag-to-keyword dictionary comprises an additional keyword corresponding to the tag.

18. The computer system of claim 15, wherein extracting the code change event further comprises:
detecting an addition to a source code repository, the addition comprising a document describing the addition;
generating, using a natural language processing engine, a summary of the document;
determining, by comparing the summary to the keyword set, that the document comprises the code change event; and
extracting, from the summary, the code change event.

19. The computer system of claim 15, further comprising:
generating, responsive to determining that an implementation of the update to the target system monitoring query is triggered by the code change event, an update request comprising the code change event and a request to perform the implementation.

20. The computer system of claim 19, further comprising:
generating, using a code generation tool, the implementation.
